(19) United States
(12) Patent Application Publication
(10) Pub. No.: US 2016/0198416 A1
(43) Pub. Date: Jul. 7, 2016

(54) METHOD AND DEVICE IN A WIRELESS COMMUNICATION NETWORK

(71) Applicant: HUAWEI TECHNOLOGIES CO., LTD., Shenzhen (CN)

(72) Inventors: Hong LI, Shanghai (CN); Henrik LUNDQVIST, Kista (SE)

(73) Assignee: HUAWEI TECHNOLOGIES CO., LTD., Shenzhen (CN)

(21) Appl. No.: 15/071,865

(22) Filed: Mar. 16, 2016

Related U.S. Application Data
(63) Continuation of application No. PCT/EP2013/069245, filed on Sep. 17, 2013.

(51) Int. Cl. H04W 52/28; H04W 52/26; H04W 52/14; H04W 52/02

(52) U.S. Cl. CPC H04W 52/283; H04W 52/0277; H04W 52/265; H04W 52/146

(57) ABSTRACT

User equipment, method in a user equipment, management node and method in a management node, all aiming at saving transmission energy by decreasing transmission power of the user equipment. The user equipment is served by a serving radio network node in a heterogeneous wireless communication system comprising the radio network node, a relay node and the management node. The method comprises transmitting a request for saving transmission energy; receiving a response, comprising an instruction for decreasing the transmission power of the user equipment; and decreasing the transmission power of the user equipment when transmitting in the uplink.

### CROSS-REFERENCE TO RELATED APPLICATION

This patent application is a continuation of international application No. PCT/EP2013/069245, filed on Sep. 17, 2013, which is hereby incorporated by reference.

### TECHNICAL FIELD

Implementations described herein generally relate to a user equipment, a method in a user equipment, a management node and a method in a management node. In particular, a mechanism is herein described, for saving transmission energy of the user equipment by decreasing transmission power.

### BACKGROUND

A User Equipment (UE), also known as a mobile station, wireless terminal and/or mobile terminal is enabled to communicate wirelessly in a wireless communication network, sometimes also referred to as a cellular radio system. The communication may be made, e.g., between user equipment, between a user equipment and a wire connected telephone and/or between a user equipment and a server via a Radio Access Network (RAN) and possibly one or more core networks. The wireless communication may comprise various communication services such as voice, messaging, packet data, video, broadcast, etc.

The user equipment may further be referred to as mobile telephone, cellular telephone, computer tablet or laptop with wireless capability, etc. The user equipment in the present context may be, for example, portable, pocket-storable, hand-held, computer-comprised, or vehicle-mounted mobile devices, enabled to communicate voice and/or data, via the radio access network, with another entity, such as another user equipment or a server.

The wireless communication network covers a geographical area which is divided into cell areas, with each cell area being served by a radio network node, or base station, e.g., a Radio Base Station (RBS) or Base Transceiver Station (BTS), which in some networks may be referred to as “eNB”, “eNodeB”, “NodeB” or “B node”, depending on the technology and/or terminology used.

Sometimes, the expression “cell” may be used for denoting the radio network node itself. However, the cell may also in normal terminology be used for the geographical area where radio coverage is provided by the radio network node at a base station site. One radio network node, situated on the base station site, may serve one or several cells. The radio network nodes may communicate over the air interface operating on radio frequencies with any user equipment within range of the respective radio network node.

In some radio access networks, several radio network nodes may be connected, e.g., by landlines or microwave, to a Radio Network Controller (RNC), e.g., in Universal Mobile Telecommunications System (UMTS). The RNC, also sometimes termed Base Station Controller (BSC), e.g., in GSM, may supervise and coordinate various activities of the plural radio network nodes connected thereto. GSM is an abbreviation for Global System for Mobile Communications (originally: Groupe Special Mobile).

In 3rd Generation Partnership Project (3GPP) Long Term Evolution (LTE) radio network nodes, which may be referred to as eNodeBs or eNBs, may be connected to a gateway, e.g., a radio access gateway, to one or more core networks. LTE is based on the GSM/EDGE and UMTS/HSPA network technologies, increasing the capacity and speed using a different radio interface together with core network improvements.

LTE-Advanced, i.e. LTE Release 10 and later releases are set to provide higher bitrates in a cost efficient way and, at the same time, completely fulfil the requirements set by International Telecommunication Union (ITU) for the International Mobile Telecommunications (IMT)-Advanced, also referred to as 4G.

In the present context, the expressions downlink, downstream link or forward link may be used for the transmission path from the radio network node to the user equipment. The expression uplink, upstream link or reverse link may be used for the transmission path in the opposite direction, i.e., from the UE to the radio network node.

FIG. 1A illustrates an overview of the LTE system architecture. The high-level network architecture of LTE is comprised of following three main components: the user equipment, Evolved UMTS Terrestrial Radio Access Network (E-UTRAN) and Evolved Packet Core (EPC). EPC is the core network.

The Home Subscriber Server (HSS) component has been carried forward from UMTS and GSM and is a central database that contains information about all the network operator's subscribers.

The Packet Data Network (PDN) Gateway (P-GW) communicates with the outside world i.e. PDN, using SGi interface. Each packet data network is identified by an Access Point Name (APN). The P-GW has the same role as the GPRS Support Node (GGSN) and the Serving GPRS Support Node (SGSN) within UMTS and GSM.

The Serving Gateway (S-GW) acts as a router, and forwards data between the radio network node and the P-GW.

The Mobility Management Entity (MME) controls the high-level operation of the user equipment by means of signalling messages and the HSS.

The Policy Control and Charging Rules Function (PCRF) is a component which is not shown in the above diagram but it is responsible for policy control decision-making, as well as for controlling the flow-based charging functionalities in the Policy Control Enforcement Function (PCEF), which resides in the P-GW.

Each eNB, or radio network node, connects with the EPC by means of the S1 interface and it can also be connected to nearby eNB's by the X2 interface, which is mainly used for signalling and packet forwarding during handover. The interface between the serving and PDN gateways is known as S5/S8. This has two slightly different implementations, namely S5 if the two devices are in the same network, and S8 if they are in different networks.

FIG. 1B illustrates a heterogeneous network (Hetnet) with relay nodes. In such heterogeneous network, a user equipment usually has two means to attach to a cell: connect with the radio network node directly, or via forwarding by a relay node (RN). A prior art method of cell selection is based on the Reference Signal Received Power (RSRP), assuming the wireless channel propagation models of downlink and uplink are identical. In this scheme, a user equipment is associated with the node from which the strongest downlink power is received.

The basic principle comprises the following steps:
(a) each network node sends a pilot signal,
(b) the user equipment measures the received pilot signal strength, RSRP, from the serving network node and from neighbouring network nodes and/or relay nodes,
(c) the user equipment reports back to the serving network node the result of the measurements, and
(d) the serving network node decides whether the user equipment should attach to the radio network node or the relay node.

Typically, the user equipment is instructed to connect to the network node with the highest received pilot power, which defines the reference cell size.

By means of the RSRP based cell selection, user equipment are more likely to attach to the radio network node rather than the relay node since the radio network node has a larger transmit power than the relay node in reality.

For instance, in FIG. 1B, UE1 connects to the radio network node because it is out of the coverage of RN, though UE1 is closer to the relay node than the radio network node. The difference of transmission power between relay node and the radio network node results in that the coverage area of relay node is generally smaller than that of the radio network node. Considering the inevitable relaying errors introduced at relay node when forwarding, the actual coverage area of relay node becomes even smaller. E.g., in FIG. 1B, UE2 also connects to the radio network node although it is within the coverage of the relay node, since the equivalent relaying channel is worse than direct channel between UE2 and the radio network node.

Towards the radio network node, the relay node acts as a user equipment. Towards the user equipment, the relay node acts as a radio network node. The user equipment may not make any logical distinction between a cell created by a relay node and the cell created by a regular radio network node. In fact the user equipment may not even be aware of the existence of the radio backhaul connection.

The relay nodes, or pico/micro stations as they also may be referred to, usually have smaller coverage than the radio network node, or macro base station, due to the lower transmit power. A common problem when relaying in half-duplex is that effective data-rate performance for some user equipment may actually be degraded when using relay nodes. Thus the user equipment connects to the radio network node even if its location is much closer to a relay node, which works well for throughput but not for energy saving for user equipment.

It appears that there is room for improvement for a method of accessing a user equipment to a heterogeneous network.

### SUMMARY

It is therefore an object to obviate at least some of the above mentioned disadvantages and to improve the performance of a user equipment (UE) in a wireless communication network.

This and other objects are achieved by the features of the appended independent claims.

Further implementation forms are apparent from the dependent claims, the description and the figures.

According to a first aspect, a method is provided, for use in a user equipment. The method aims at saving transmission energy by decreasing transmission power of the user equipment, which user equipment is served by a serving radio network node in a heterogeneous wireless communication system. The heterogeneous wireless communication system comprises the radio network node, a relay node and a management node. The method comprises transmitting a request for saving transmission energy. Also, the method in addition comprises receiving a response, comprising an instruction for decreasing the transmission power of the user equipment. The method in addition also comprises decreasing the transmission power of the user equipment, when transmitting in the uplink.

In a first possible implementation of the method according to the first aspect, the method also comprises detecting a battery energy level of the user equipment, which is lower than a threshold level.

In a second possible implementation of the method according to the first possible implementation, the battery threshold level is not a fixed level, but based on an estimation of whether the remaining battery level will be sufficient to support the active services for a predicted time until the battery can be recharged.

In a third possible implementation of the method according to the first aspect, or any of the previous implementations, the decrease of the transmission power of the user equipment may be made based on a decrease of the Quality of Service (QoS) of the user equipment, for transmissions in the uplink.

In a fourth possible implementation of the method according to the third possible implementation, the decrease of the transmission power of the user equipment may be made when a user permission is retrieved.

In a fifth possible implementation of the method according to the first aspect, or any of the previous implementations, the method comprises the further action of establishing an uplink connection with the relay node, for enabling forwarding of a signal from the user equipment to the radio network node via the relay node may be comprised. Further, the decrease of the transmission power of the user equipment may be enabled due to the established uplink connection with the relay node.

In a sixth possible implementation of the method according to the first aspect, or any of the previous possible implementations, the request for saving transmission energy may comprise location information related to the user equipment, for enabling a geographical localisation of the user equipment.

In a seventh possible implementation of the method according to the first aspect, or any of the previous possible implementations, the transmitted request for saving transmission energy comprises information characterising how the energy consumption of the user equipment may be dependent on the transmission power of the user equipment.

In an eighth possible implementation of the method according to the first aspect, or any of the previous possible implementations, the request for saving transmission energy is transmitted to the management node, which in response prepare an instruction for decreasing the transmission power of the user equipment.

In a ninth possible implementation of the method according to the first aspect, or any of the previous possible implementations, information confirming that the user equipment is in saving energy mode is communicated over an intra-radio network node connection, such as S1 and/or X2, enabling the user equipment to continue transmitting in saving energy mode also after a hand-over.

In a tenth possible implementation of the method according to the first aspect, or any of the previous possible implementations, the request for saving transmission energy comprises a transmission power threshold of the user equipment.

According to a second aspect, a user equipment is provided, configured for saving transmission energy by decreasing transmission power of the user equipment, which user equipment is served by a serving radio network node in a heterogeneous wireless communication system. The heterogeneous wireless communication system comprises the radio network node, a relay node and a management node. The user equipment comprises a processor, configured for decreasing the transmission power of the user equipment, when transmitting in the uplink. Further, the user equipment also comprises a transmitter, configured for transmitting a request for saving transmission energy. The user equipment also furthermore comprises a receiver, configured for receiving a response, comprising an instruction for decreasing the transmission power of the user equipment.

In a first possible implementation of the user equipment according to the second aspect, the processor may be configured for detecting a battery energy level of the user equipment, which is lower than a battery energy threshold level.

In a second possible implementation of the user equipment according to the first possible implementation, the processor may be further configured for estimating whether the remaining battery level will be sufficient to support the active services for a predicted time until the battery can be recharged and detect the battery energy level of the user equipment, when the remaining battery level is not sufficient.

In a third possible implementation of the second aspect, or any previous implementation, the processor may be further configured for decreasing the transmission power of the user equipment by decreasing the Quality of Service (QoS) of the user equipment, for transmissions in the uplink.

In a fourth possible implementation of the second aspect according to any previous implementation, the processor may be further configured for decreasing the transmission power of the user equipment when a user permission is retrieved.

In a fifth possible implementation of the second aspect according to any previous implementation, the processor may be further configured for establishing an uplink connection with the relay node, for enabling forwarding of a signal from the user equipment to the radio network node via the relay node, and thereby decrease the transmission power of the user equipment.

In a sixth possible implementation of the second aspect according to any previous implementation, the processor may be further configured for obtaining location information related to the user equipment, and may also be configured for adding said location information to the request for saving transmission energy, thereby enabling geographical localisation of the user equipment for the recipient of the request.

In a seventh possible implementation of the second aspect according to any previous implementation, the processor may be further configured for obtaining information characterising how the energy consumption of the user equipment may depend on the transmission power of the user equipment, and may also be configured for adding said information to the request for saving transmission energy.

In an eighth possible implementation of the second aspect according to any previous implementation, the processor may be further configured for computing a transmission power threshold of the user equipment and add said transmission power threshold to the request for saving transmission energy to be transmitted.

In a ninth possible implementation of the second aspect according to any previous implementation, the radio network node may comprise an evolved NodeB (eNodeB). Further, the heterogeneous wireless communication network may be based on 3rd Generation Partnership Project Long Term Evolution (3GPP LTE). In addition, the management node may comprise a Mobility Management Entity (MME).

According to a third aspect, a computer program is provided, comprising program code for performing a method for use in a user equipment for saving transmission energy by decreasing transmission power of the user equipment, when the computer program is loaded into a processor of the user equipment.

According to a fourth aspect, a computer program product is provided, comprising a computer readable storage medium storing program code thereon for use by a user equipment, for saving transmission energy by decreasing transmission power of the user equipment. The program code comprises instructions for executing a method, comprising transmitting a request for saving transmission energy. Also, the method furthermore in addition comprises receiving a response, comprising an instruction for decreasing the transmission power of the user equipment. The method also comprises decreasing the transmission power of the user equipment, when transmitting in the uplink.

According to a fifth aspect, a method is provided for use in a management node in a heterogeneous wireless communication system comprising a radio network node, a relay node and the management node. A user equipment is attached to the wireless communication system served by the radio network node. The method comprises saving transmission energy of the user equipment by decreasing transmission power of the user equipment. The method comprises receiving a request for saving transmission energy from the user equipment. Further, the method comprises locating the user equipment having transmitted the request. The method also comprises deciding to reduce the transmission energy of the user equipment. Also, the method furthermore comprises transmitting a response, comprising an instruction for decreasing the transmission power of the user equipment, to be received by the user equipment.

In a first possible implementation of the fifth aspect, the decision to reduce the transmission energy of the user equipment may be based on a decrease of the Quality of Service (QoS) of the user equipment in the uplink, when the channel quality between the user equipment and the serving radio network node exceeds a threshold quality value.

In a second possible implementation of the fifth aspect, the decision to reduce the transmission energy of the user equipment may be based on a rerouting of uplink signals from the user equipment to the radio network node via the relay node when channel quality between the user equipment and the relay node exceeds the channel quality between the user equipment and the radio network node.

In a third possible implementation of the fifth aspect according to any of the previously described possible implementations, the location of the user equipment may be based on location information received from the user equipment.

In a fourth possible implementation of the fifth aspect according to any of the previously described possible implementations, the location of the user equipment may be based on information retrieved from a location service.

According to a sixth aspect, a management node in a heterogeneous wireless communication system is provided, comprising a radio network node, a relay node and the management node. A user equipment is attached to the wireless communication system served by the radio network node. The management node comprises a receiver, configured for receiving a request for saving transmission energy, from the user equipment. The management node also comprises a processor, configured for locating the user equipment having transmitted the request, and also configured for deciding to reduce the transmission energy of the user equipment. Furthermore, the management node also may comprise a transmitter, configured for transmitting a response, comprising an instruction for decreasing the transmission power of the user equipment, to be received by the user equipment.

In a first possible implementation of the sixth aspect, the processor may be further configured for determining that the user equipment may be located closer to the serving radio network node than a threshold distance, and also configured for decreasing the QoS of the user equipment in the uplink.

In a second possible implementation of the sixth aspect, the processor may be further configured for determining that the channel quality between the user equipment and relay node exceeds the channel quality between the user equipment and the radio network node, and also configured for rerouting uplink signals of the user equipment, to the radio network node via the relay node.

In a third possible implementation of the sixth aspect according to any of the previously made possible implementations, the processor may be further configured for retrieving location information from a location service and for locating the user equipment, based on such retrieved information.

In a fourth possible implementation of the sixth aspect according to any of the previously made possible implementations, the radio network node may comprise an evolved NodeB (eNodeB). Also, the heterogeneous wireless communication network may be based on 3rd Generation Partnership Project Long Term Evolution (3GPP LTE). Furthermore, the management node may comprise a Mobility Management Entity (MME).

According to a seventh aspect, a computer program comprising program code is provided, for performing a method for use in a management node, for saving transmission energy by decreasing transmission power of a user equipment when the computer program is loaded into a processor of the management node.

According to an eighth aspect, a computer program product is provided, comprising a computer readable storage medium storing program code thereon for use by a management node, for saving transmission energy by decreasing transmission power of a user equipment. The program code comprises instructions for executing a method, comprising receiving a request for saving transmission energy from the user equipment. The method also comprises locating the user equipment having transmitted the request. Further, the method also comprises deciding to reduce the transmission energy of the user equipment. The method comprises transmitting a response, comprising an instruction for decreasing the transmission power of the user equipment, to be received by the user equipment.

By allowing a user equipment, connected to the network via the radio network node, to connect via a relay node in the uplink, when the user equipment is geographically located closer to the relay node than the serving radio network node, the transmission power of the user equipment may be reduced, in comparison with transmitting directly to the more remotely situated radio network node in the uplink. Thereby, energy is saved at the user equipment, which may prolong the battery activity time between re-charge. Also, the reduced transmission power of the user equipment generates less uplink interference within the system. The user equipment may request the network to take some measures to save energy, for example when low battery is detected on the user equipment. At receiving the request, the network may figure out a scheme and reconfigure the connection of the user equipment to save energy by taking the topology and required QoS/QoE into account. The reconfiguration may involve multiple nodes, and may therefore introduce some new signalling in RRC and S1 and X2 application protocols.

For the user equipment located around cell edge of a relay node attached to the radio network node, reroute the user equipment's uplink from the radio network node to a nearby relay node and keeping downlink with the radio network node. In some cases, for user equipment located very close to either the radio network node and/or the relay node on uplink by decreasing users' QoS grade. Thereby an improved performance within the wireless communication network is provided.

Other objects, advantages and novel features of the aspects of the invention will become apparent from the following detailed description.

### BRIEF DESCRIPTION OF THE DRAWINGS

Various embodiments are described in more detail with reference to attached drawings, illustrating examples of embodiments of the invention in which:

FIG. 1A is a block diagram illustrating a wireless communication network according to prior art.

FIG. 1B is a block diagram illustrating a wireless communication network according to prior art.

FIG. 2 is a block diagram illustrating a wireless communication network according to some embodiments of the invention.

FIG. 3 is a block diagram illustrating a wireless communication network architecture according to some embodiments of the invention.

FIG. 4A is a combined flow chart and signalling scheme illustrating a method according to an embodiment.

FIG. 4B is a combined flow chart and signalling scheme illustrating a method according to an embodiment.

FIG. 5 is a flow chart illustrating a method in a user equipment according to an embodiment.

FIG. 6A is a block diagram illustrating a user equipment according to an embodiment.

FIG. 6B is a block diagram illustrating a user equipment according to an alternative embodiment.

FIG. 7 is a flow chart illustrating a method in a management node according to an embodiment.

FIG. 8A is a block diagram illustrating a management node according to an embodiment.

FIG. 8B is a block diagram illustrating a management node according to an alternative embodiment.

### DETAILED DESCRIPTION

Embodiments of the invention described herein are defined as a user equipment, a method in a user equipment, a management node and a method in a management node, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

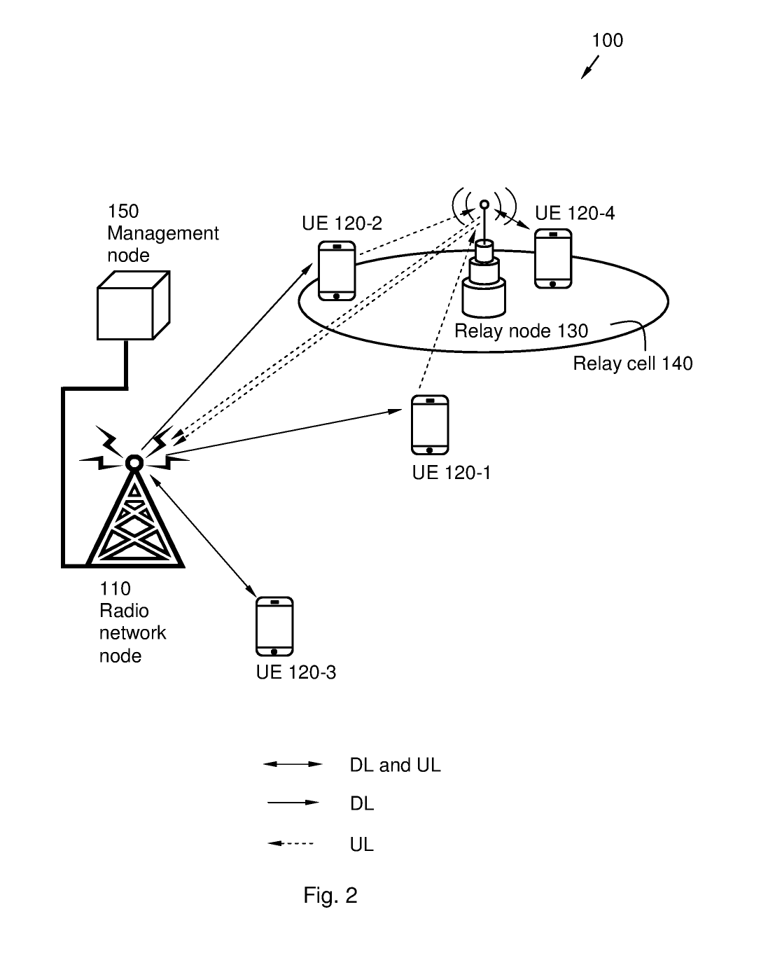

FIG. 2 is a schematic illustration over a wireless communication network 100 comprising a radio network node 110 a number of user equipment (UE) 120-1, 120-2, 120-3, 120-4, a relay node 130 defining a relay cell 140 and a management node 150.

The wireless communication network 100 may at least partly be based on radio access technologies such as, e.g., 3GPP LTE, LTE-Advanced, Evolved Universal Terrestrial Radio Access Network (E-UTRAN), Universal Mobile Telecommunications System (UMTS), Global System for Mobile Communications (originally: Groupe Special Mobile) (GSM)/Enhanced Data rate for GSM Evolution (GSM/EDGE), Wideband Code Division Multiple Access (WCDMA), Time Division Multiple Access (TDMA) networks, Frequency Division Multiple Access (FDMA) networks, Orthogonal FDMA (OFDMA) networks, Single-Carrier FDMA (SC-FDMA) networks, Worldwide Interoperability for Microwave Access (WiMax), or Ultra Mobile Broadband (UMB), High Speed Packet Access (HSPA) Evolved Universal Terrestrial Radio Access (E-UTRA), Universal Terrestrial Radio Access (UTRA), GSM EDGE Radio Access Network (GERAN), 3GPP2 CDMA technologies, e.g., CDMA2000 1×RTT and High Rate Packet Data (HRPD), just to mention some few options. The expressions “wireless communication network”, “wireless communication system” and/or “cellular telecommunication system” may within the technological context of this disclosure sometimes be utilised interchangeably.

The wireless communication network 100 may be configured to operate according to the Time Division Duplex (TDD) and/or the Frequency Division Duplex (FDD) principle, according to different embodiments.

TDD is an application of time-division multiplexing to separate uplink and downlink signals in time, possibly with a Guard Period (GP) situated in the time domain between the uplink and downlink signalling. FDD means that the transmitter and receiver operate at different carrier frequencies.

The purpose of the illustration in FIG. 2 is to provide a simplified, general overview of the wireless communication network 100 and the involved methods and nodes, such as the radio network node 110, relay node 130 and user equipment 120 herein described, and the functionalities involved. The methods, radio network node 110, relay node 130 and user equipment 120 will subsequently, as a non-limiting example, be described in a 3GPP LTE/LTE-Advanced environment, but the embodiments of the disclosed methods, radio network node 110, relay node 130 and user equipment 120 may operate in a wireless communication network 100 based on another access technology such as, e.g., any of the above already enumerated. Thus, although the embodiments of the invention are described based on, and using the lingo of, 3GPP LTE systems, it is by no means limited to 3GPP LTE.

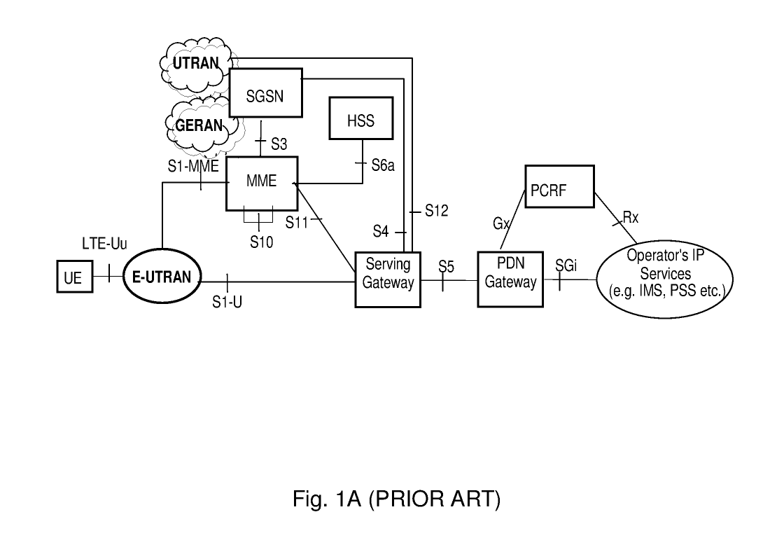

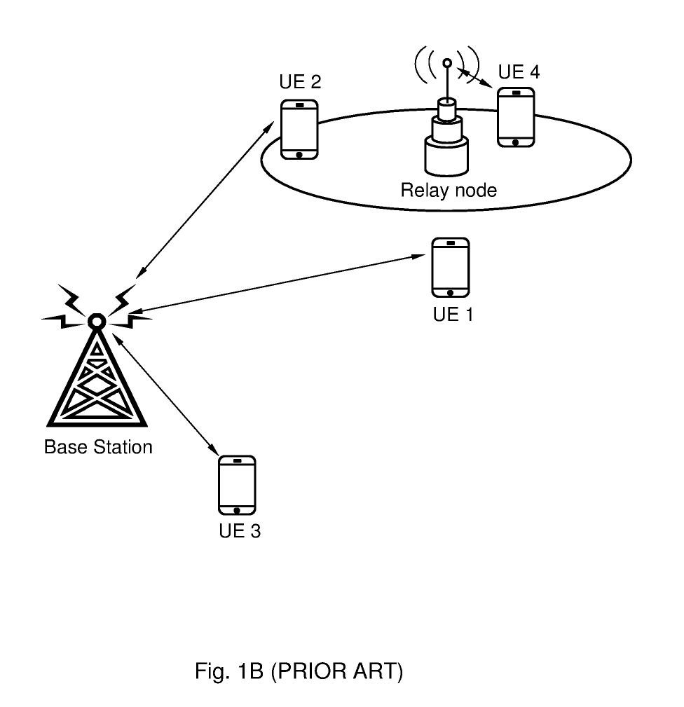

The illustrated wireless communication network 100 comprises the radio network node 110, which may send and receive radio signals in order to communicate wirelessly with the user equipment 120. The radio network node 110 is also connected to a management node 150, which may be referred to as a Mobility Management Entity (MME), and also to the core network via a gateway or similar node (as illustrated in FIG. 1A).

It is to be noted that the illustrated network setting of one radio network node 110, one relay node 130 and four user equipment 120 in FIG. 2 is to be regarded as a non-limiting example of an embodiment only. The wireless communication network 100 may comprise any other number and/or combination of radio network nodes 110, relay nodes 130 and/or user equipment 120. A plurality of user equipment 120 and another configuration of radio network nodes 110 and/or relay nodes 130 may thus be involved in some embodiments of the disclosed invention.

Thus whenever “one” or “a/an” radio network node 110, relay node 130 and/or user equipment 120 is referred to in the present context, a plurality of radio network nodes 110, relay nodes 130 and/or user equipment 120 may be involved, according to some embodiments.

The radio network node 110 may according to some embodiments be configured for downlink transmission and uplink reception, and may be referred to, respectively, as e.g., a base station, a NodeB, an evolved Node Bs (eNB, or eNode B), a base transceiver station, an Access Point Base Station, a base station router, a Radio Base Station (RBS), a micro base station, a pico base station, a femto base station, a Home eNodeB, a sensor, a beacon device, a relay node, a repeater or any other network node configured for communication with the user equipment 120 over a wireless interface, depending, e.g., of the radio access technology and/or terminology used.

The relay node 130 may according to some embodiments be configured for downlink transmission and uplink reception, and may be referred to, respectively, as e.g., a micro base station, a pico base station, a femto base station, a Home eNodeB, a sensor, a beacon device, a relay node, a repeater or any other network node configured for communication with the user equipment 120 over a wireless interface, depending, e.g., of the radio access technology and/or terminology used.

The user equipment 120 may correspondingly be represented by, e.g. a wireless communication terminal, a mobile cellular phone, a Personal Digital Assistant (PDA), a wireless platform, a mobile station, a tablet computer, a portable communication device, a laptop, a computer, a wireless terminal acting as a relay, a relay node, a mobile relay, a Customer Premises Equipment (CPE), a Fixed Wireless Access (FWA) nodes or any other kind of device configured to communicate wirelessly with the radio network node 110 and/or the relay node 130, according to different embodiments and different vocabulary.

Some embodiments of the invention define a modular implementation approach, and make it possible to reuse legacy systems such as e.g. standards, algorithms, implementations, components and products. The modular architecture also scales up/down to support implementations on e.g. small cell BTS products.

A user equipment 120 according to embodiments of the invention may request the network 100 to take some measures to save energy at the user side, for example when low battery is detected at the user equipment 120. When receiving such request, the management node 150 in the network 100 figures out a scheme and reconfigures the connection of the user equipment 120 to save energy by taking the topology and required QoS/QoE into account. The reconfiguration may involve multiple nodes, and may therefore be implemented based on signalling in a Radio Resource Control (RRC), S1 and X2 application protocols.

According to some embodiments, the user equipment 120 may trigger network to save energy for the user equipment 120, e.g. when the battery gets lower than some threshold level. The first user equipment 120-1 and second user equipment 120-2, which in the illustrated example is situated close to the cell edge of the relay node 130, inside or outside the relay cell 140 while the first user equipment 120-1 and second user equipment 120-2 are attached to the radio network node 110; reroute the first user equipment 120-1 and/or the second user equipment 120-2 in the uplink from the radio network node 110 to a nearby relay node 130 and keeping downlink connection with the radio network node 110.

However, for the third user equipment 120-3 and/or the fourth user equipment 120-4, which may be situated very close to either the radio network node 110 and/or the relay node 130, to decrease transmission power of the third user equipment 120-3 and/or the fourth user equipment 120-4 respectively, on the uplink they cannot be rerouted to another path, instead lower transmission power can be achieved by decreasing the QoS grade of the third user equipment 120-3 and/or the fourth user equipment 120-4. This may be made e.g. by transmitting a question and present that to the user of the third user equipment 120-3 and/or the fourth user equipment 120-4 respectively.

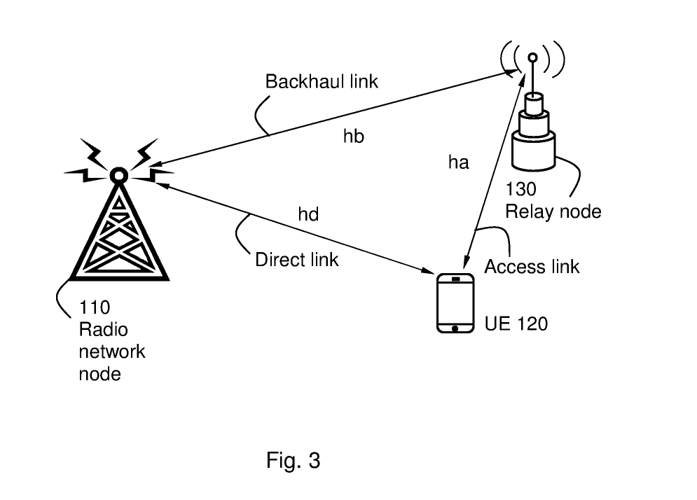

FIG. 3 presents a scenario in a heterogeneous network 100 comprising a radio network node 110 and a relay node 130. Three links are involved in the relay system on the uplink channel: direct link hd, access link ha and backhaul link hb. The radio network node 110 and the relay node 130 are connected via a wired or wireless backhaul link hb. Also a user equipment 120 is situated somewhere in between the radio network node 110 and the relay node 130 and may potentially be served by one of these nodes. Thus the user equipment 120 may connect to the relay node 130 over an access link ha, or to the radio network node 110 via a direct link hd.

When the user equipment 120 is close to the cell edge of the relay node 130, a stronger pilot signal (RSRP) may be received from the radio network node 110 than from the relay node 130 because the radio network node 110 usually has a much larger transmit power than the relay node 130, even if the user equipment 120 is situated geographically closer to the relay node 130 than to the radio network node 110 and thereby consume more energy when transmitting uplink signals than if a connection instead were made to the closer situated relay node 130. Thereby the user equipment 120 battery is drained. This is a problem, as the user equipment 120 has limited battery capacity due to high demands on portability. Further, increased uplink interference between user equipment in the cell is introduced into the system, as a user equipment transmitting on high power also generates more interference.

Thus, for some user equipment 120 situated around the cell edge of the relay node 130, but attached to the radio network node 110, the transmit power of the user equipment 120 on uplink may be decreased by redirecting the uplink of the user equipment 120 from the radio network node 110 to the relay node 130. This is the situation that has been illustrated in FIG. 2, for the first user equipment 120-1 and the second user equipment 120-2, which both are situated close to the cell edge of the relay node 130, but attached to the radio network node 110. Thereby, energy is saved at the user equipment 120, which means that the battery lifetime between charging may be prolonged. Alternatively, a smaller battery may be used in the user equipment 120, thereby enabling a slimmer design and increased portability of the user equipment 120. Also production costs may thereby be reduced, as less material is utilised. Further, transmitting on lower power may enable use of cheaper power amplifiers in the user equipment 120, which further may reduce the production costs of the user equipment. Alternatively, the lifetime of the power amplifiers in the user equipment may be prolonged. In further addition, by enabling the user equipment 120 to transmit via the relay node 130 in the uplink, uplink interference may be reduced, as transmitting on less power also generates less uplink interference.

According to some embodiments, the uplink of some user equipment 120 situated around the cell edge of the relay node 130 may be redirected from the radio network node 110 to the relay node 130, but the downlink connection may be kept to the radio network node 110. An advantage is that the user equipment 120 thereby may utilise the better throughput and signal quality of the downlink signals from the radio network node 110, while transmitting on the uplink via the relay node 130 and thereby save energy for the user equipment 120.

The channel quality of the backhaul link hb between the relay node 130 and the radio network node 110 may be guaranteed by tuning the transmit power of the relay node 130. The accurate transmit powers of the user equipment 120 and the relay node 130 without loss of QoS may be calculated by network, e.g. by the radio network node 110.

Meanwhile Additive White Gaussian Noise (AWGN) is considered in the wireless communication network 100.

When the user equipment 120 transmits signal s_1 to the radio network node 110 via the direct link hd, the received signal at the radio network node 110 may be given by:

r_{d}=\sqrt{p_{d}^{u}}h_{d}s₁+I_{d}+n [Equation 1]

where p_{d}^{u} is the power of signal transmission of the user equipment 120, n₀ is the thermal noise, I_{d} is the interference from other user equipment in the whole network 100; the thermal noise I_{d} and interference I_{d} are assumed as Gaussian noise with expectation value zero and variance equal to σ² at receiver.

Thus the capacity of transmission on direct link hd with bandwidth equal to one is:

$${C}_{d} ( {p}_{d}^{u} ) = {log}_{2} ( 1 + \frac{{p}_{d}^{u} {‖ {h}_{d} ‖}^{2}}{{‖ {I}_{d} ‖}^{2} + {σ}^{2}} ) \qquad [ Equation 2 ]$$

When the user equipment 120 transmits signal s₁ to the radio network node 110 via relay node 130 forwarding, the signal will be transmitted on access link and backhaul link successively. The received signal at the relay node 130 and the radio network node 110 may be given by:

rₐ=\sqrt{pₐ^{u}}hₐs₁+Iₐ+n, [Equation 3]

r_{b}=\sqrt{p_{b}^{r}}h_{b}s₁+I_{b}+n, [Equation 4]

where pₐ^{u}, p_{b}^{r}, are the transmit power of the user equipment 120 and the relay node 130 respectively, Iₐ and I_{b} are the interference from other cell. Similarly, the capacity on the access link ha and backhaul link hb can be expressed as follows:

$$\begin{matrix}{C}_{a} ( {p}_{a}^{u} ) = {log}_{2} ( 1 + \frac{{p}_{a}^{u} {‖ {h}_{a} ‖}^{2}}{{‖ {I}_{a} ‖}^{2} + {σ}^{2}} ) , & [ Equation 5 ] \\ {C}_{b} ( {p}_{b}^{r} ) = {log}_{2} ( 1 + \frac{{p}_{b}^{r} {‖ {h}_{b} ‖}^{2}}{{‖ {I}_{b} ‖}^{2} + {σ}^{2}} ) , & [ Equation 6 ]\end{matrix}$$

The general capacity of forwarding by the relay node 130 is given,

C′(pₐ^{u}p_{b}^{r})=min(Cₐ,C_{b}), [Equation 7]

The utility function may be defined as

min αf(pₐ^{u})+(1−α)g(p_{b}^{r}), 0≦α≦1

s.t.C′(pₐ^{u},p_{b}^{r})≧C_{d},

pₐ^{u}≦p_{d}^{u}, [Equation 8]

where f( ) and g( ) are the energy consumption functions of the user equipment 120 and the relay node 130 respectively. α is the weight coefficient between f( ) and g( ), implying the trade-off of energy consumption between the user equipment 120 and the relay node 130. The transmit power of the user equipment 120 on uplink after rerouting may be set according to the solution to [Equation 8]. The optimization problem [Equation 8] may be solved by the network 100, either by some standalone entity or by a logic function in the management node 150 or the radio network node 110 according to different embodiments.

The utility function in [Equation 8] may capture how the energy consumption of the user equipment 120 depends on the respective transmission powers pₐ^{u} and p_{b}^{r}. An important factor is the energy consumption of the user equipment 120, therefore the energy consumption functions of the user equipment 120, f( ) will take higher values than the energy consumption functions of the relay node 130, g( ) even when the transmission powers are the same. A typical behaviour of current power amplifiers is that they comprises two modes, where the energy consumption increases significantly when the output power increases above some threshold level, for example 10 dBm. The function f( ) might then for example be approximated with a piece wise linear function, such as:

f(p)=k₁p+m₁,p<p_{threshold}

f(p)=k₂p+m₂,p≧p_{threshold}

Hence it may be of advantage for the wireless communication system 100 to be aware of the parameters k₁, k₂, m₁, m₂ and p_{threshold}. It would also be possible to use more accurate models of the function f( ). A more accurate model would allow more optimal solutions to the optimization problem in [Equation 8], but it would increase the complexity in terms of signalling and implementation. Therefore, using only the power threshold level, p_{threshold}, as a single parameter characterization of f( ) is a trade-off between the accuracy and complexity that seems like a preferred embodiment that level is to be able to configure the transmission power of the user equipment 120 and the backhaul node in an efficient way. Since such a threshold level may be configurable and may vary between different user equipments, in particular when user equipment designed in different years are considered, the user equipment 120 may signal this information to the network. In particular, this signalling can be interpreted by the network as a preference to have a transmission power lower than the threshold level p_{threshold}.

For the user equipments for which the transmit power cannot be decreased by splitting the downlink and uplink connection, e.g., a user equipment very close to the radio network node 110 or the relay node 130, the transmit power of the user equipment 120 on uplink could be also decreased by decreasing users' QoS grade. Returning briefly to FIG. 2, this may be the case for the third user equipment 120-3 and/or the fourth user equipment 120-4. The decision of decreasing QoS grade to save energy may be permitted by user, which could be maintained at network as user's subscription or signalled by UE assistance information according to some embodiments. Note that the UE assistance information may be extended to comprise the threshold information described above.

When the reconfiguration comprises multiple nodes in the wireless communication system 100, for example a management node 150 and multiple radio network nodes 110, or a radio network nodes 110 and a relay node 130, the nodes that have not been involved in solving the optimization problem [Equation 8] may be informed that some reconfiguration has been made for the purpose of energy saving at the user equipment 120. This may be done e.g. by defining a new cause value for in the S1 and X2 application protocols. The new cause value may inform the involved node that the new configuration is intended to save energy for the user equipment 120, and they may therefore maintain this configuration after a handover even if it may not be optimal from a performance point of view.

The management node 150 may make measurements and/or configurations of the user equipment 120 and other nodes such as e.g. relay nodes 130 to make channel measurements. Based on the measurements it may handle the processing to identify the access mode with best trade-off between energy efficiency and QoS and for this purpose maintains the network layout map and search relay node for the user equipment 120 to reconnect. Further, the management node 150 may determine the optimal transmit power for the user equipment 120 in terms of energy saving and instruct the radio network node 110 to do the power control. Furthermore, according to some embodiments, the management node 150 may maintain a network layout map in a local database.

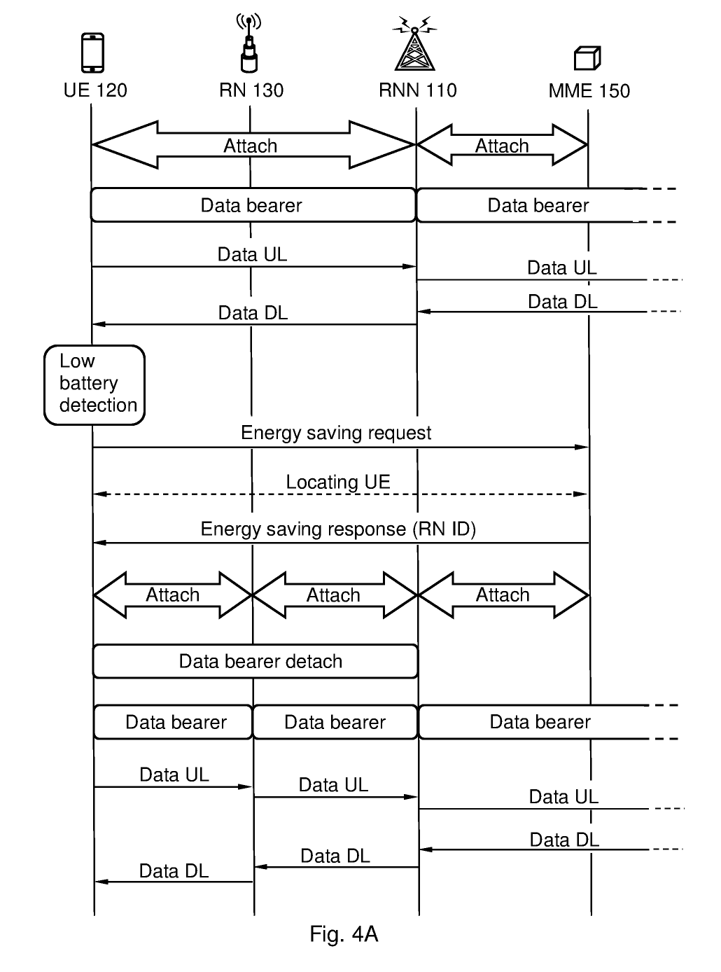

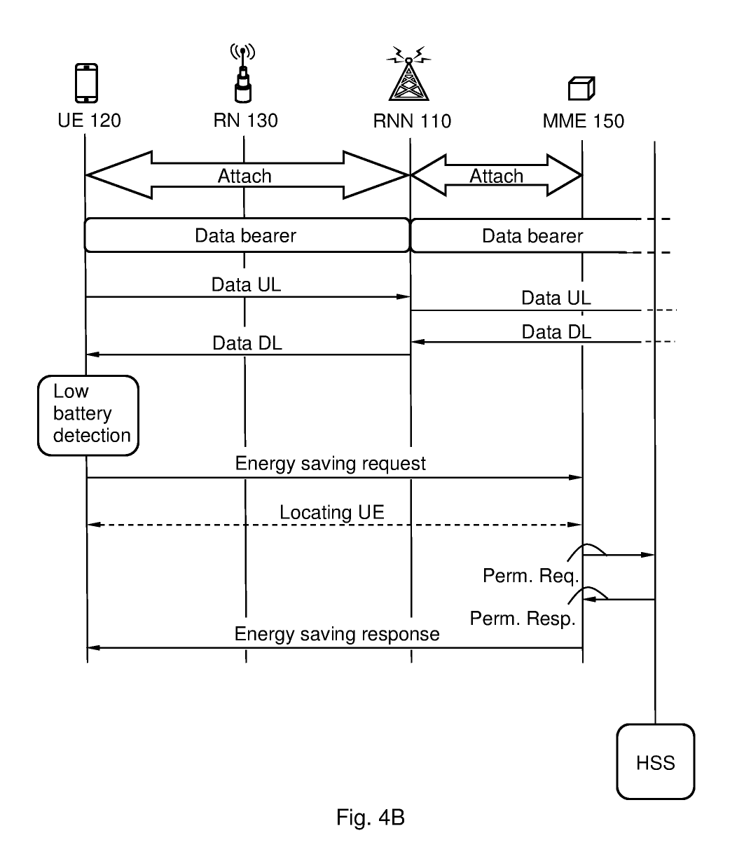

FIG. 4A illustrates an embodiment of the invention and some of the signalling involved among the entities in the wireless communication system 100.

The user equipment 120 with full battery, or at least a battery load exceeding a threshold value, initially may access the network for best quality of experience by attaching to the radio network node 110 for both downlink and uplink. The user equipment 120 may transmit a request to the network, e.g. to the management node 150, to save energy to prolong the usage when low battery is detected. The request message may be sent to the management node 150. The management node 150 may look up the local map to get the surrounding network layout near to the user equipment 120, when the user equipment 120 comprises its location information in the energy saving request. A location service to obtain location of the user equipment 120 may be triggered by the management node 150 if it is not comprised in the energy saving request. The management node 150 may figure out the possible schemes to save energy based on the surrounding network information. It shows in this example that the transmit power of the user equipment 120 may be decreased by rerouting uplink to a nearby relay nodes 130 without loss of QoS after measurement and calculation. The management node 150 may respond the user equipment 120 with the identifier of the relay node 130. The user equipment 120 may then establish connection and data bearer with the relay node 130 for uplink, keeping the downlink with the radio network node 110. The user equipment 120 may transmit signals and data to the radio network node 110 via relay node forwarding on uplink while communicating with the radio network node 110 directly on downlink, according to some embodiments.

FIG. 4B illustrates yet an embodiment of the invention and some of the signalling involved among the entities in the wireless communication system 100, wherein the user equipment 120 is situated relatively close to the radio network node 110, i.e., both downlink and uplink are connected with the radio network node 110. For reference, see user equipment 120-3 in FIG. 2.

The general procedures may be similar to the previously discussed embodiment illustrated in FIG. 4A, but the management node 150 may find that the energy of the user equipment 120 cannot be saved by rerouting uplink to a nearby relay node 130 after measurement and calculation. The management node 150 may check with e.g. the Home Subscriber Server (HSS) if the operation of saving energy by decreasing QoS is permitted by the user equipment 120. The management node 150 may figure out the possible schemes of saving energy for user equipment 120 by decreasing QoS grade if it is allowed by user, e.g., decreasing the video resolution when uploading or downloading files, tuning coding and modulation schemes, decreasing user equipment 120 transmit power, etc. The management node 150 may instruct the user equipment 120 how to operate to save energy in the response message and the user equipment 120 follows the instruction.

The optimisation of energy consumption in the above embodiments may also be done in the radio network node 110. In such case, the energy saving request in FIG. 4B may be transmitted to the radio network node 110 rather than the management node 150 according to some alternative embodiments.

Thereby, energy may be saved for the user equipment 120 within the heterogeneous wireless communication system 100, comprising a relay node 130.

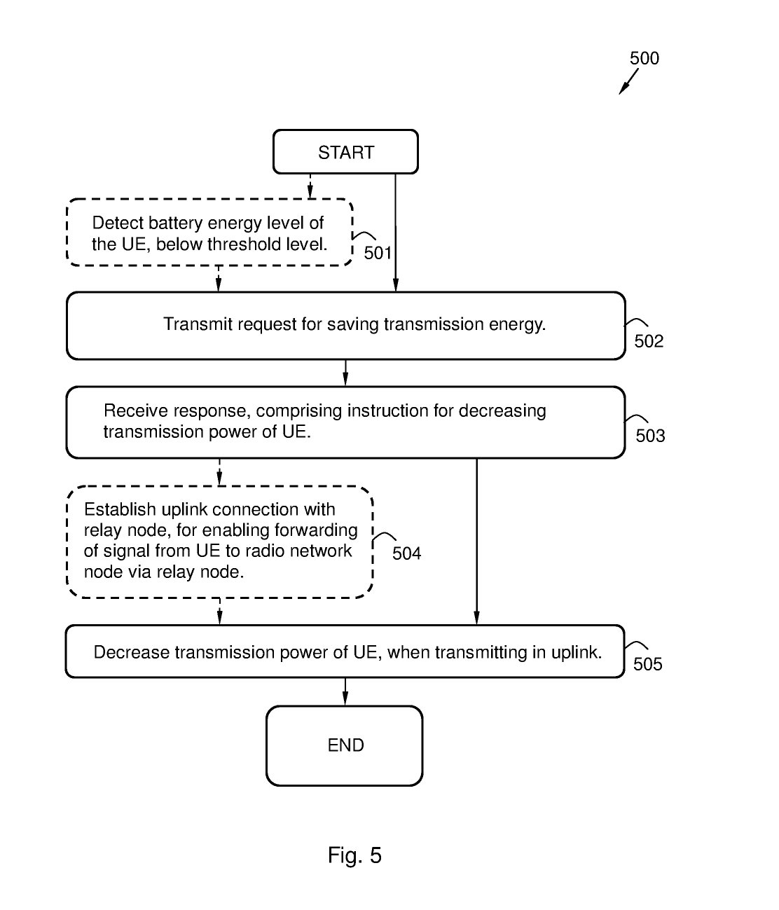

FIG. 5 is a flow chart illustrating embodiments of a method 500 for use in a User Equipment (UE) 120. The method 500 aims at saving transmission energy by decreasing transmission power of the user equipment 120, which user equipment 120 is served by a serving radio network node 110 in a heterogeneous wireless communication system 100 comprising the radio network node 110, a relay node 130 and a management node 150.

The wireless communication network 100 may be based on 3GPP LTE. Further, the wireless communication system 100 may be based on FDD or TDD in different embodiments. The radio network node 110 may comprise an evolved NodeB (eNodeB) according to some embodiments. The management node 150 may comprise a Mobility Management Entity (MME). The relay node 130 may comprise a micro node, a pico node, a nano node, or similar entity.

According to some embodiments, information confirming that the user equipment 120 is in saving energy mode may be communicated over an intra-radio network node connection, such as S1 and/or X2, enabling the user equipment 120 to continue transmitting in saving energy mode also after a hand-over.

To appropriately save transmission energy by decreasing transmission power of the user equipment 120, the method 500 may comprise a number of actions 501-505.

It is however to be noted that any, some or all of the described actions 501-505, may be performed in a somewhat different chronological order than the enumeration indicates, be performed simultaneously or even be performed in a completely reversed order according to different embodiments. Also, some actions such as e.g. actions 501 and/or 504 may be performed only within some embodiments. Further, it is to be noted that some actions may be performed in a plurality of alternative manners according to different embodiments, and that some such alternative manners may be performed only within some, but not necessarily all embodiments. The method 500 may comprise the following actions:

### Action 501

This action may be performed within some, but not necessarily all embodiments of the method 500.

A battery energy level of the user equipment 120, which is lower than a battery energy threshold level may be detected.

The threshold level may be predetermined or configurable according to different embodiments. In some embodiments, the battery energy threshold level may be set to e.g. 50%, 25%, 10%, 1% or a threshold level set to an approximately similar level, or a level in between the enumerated examples of battery energy threshold levels. Further, different user equipment may have different battery energy threshold levels, based on e.g. capacity, production year, capability etc.

The battery energy threshold level for indicating low battery level does not have to be a fixed level, it may alternatively be determined in relation to the active services of the user equipment 120. A context aware power management may for example request energy saving when it estimates that the remaining battery level will not be sufficient to support the active services for the predicted time until the battery can be recharged. Such prediction can be based on for example typical moving trajectories of the user, and the service life time may be predicted for example by typical usage patterns or by the length of a video the user is watching according to different embodiments.

The detection of low battery level may trigger the performance of the subsequently following actions 502-505 in some embodiments.

### Action 502

A request for saving transmission energy is transmitted.

The request for saving transmission energy may in some embodiments comprise location information related to the user equipment 120, for enabling a geographical localisation of the user equipment 120.

The request for saving transmission energy may in some embodiments comprise information characterising how the energy consumption of the user equipment 120 depends on the transmission power of the user equipment 120.

Further, the request for saving transmission energy may comprise a transmission power threshold of the user equipment 120, according to some embodiments.

According to some embodiments, the request for saving transmission energy may be transmitted to be received by the management node 150, which in response may prepare an instruction for decreasing the transmission power of the user equipment 120.

However, in some embodiments, the user equipment 120 may transmit the request to the radio network node 110 and/or alternatively to the relay node 130.

### Action 503

A response, comprising an instruction for decreasing the transmission power of the user equipment 120 is received.

Such response may be prepared and transmitted from the management node 150 according to some embodiments.

### Action 504

This action may be performed within some, but not necessarily all embodiments of the method 500.

An uplink connection with the relay node 130 may be established, for enabling forwarding of a signal from the user equipment 120 to the radio network node 110 via the relay node 130, and wherein the decrease of the transmission power of the user equipment 120 may be enabled due to the established uplink connection with the relay node 130, according to some embodiments.

### Action 505

The transmission power of the user equipment 120, when transmitting in the uplink, is decreased.

The decrease of the transmission power of the user equipment 120 may be made based on a decrease of the Quality of Service (QoS) of the user equipment 120, for transmissions in the uplink.

The decrease of the transmission power of the user equipment 120 may be made when a user permission is retrieved, e.g. from a Home Subscriber Server (HSS), or similar data base.

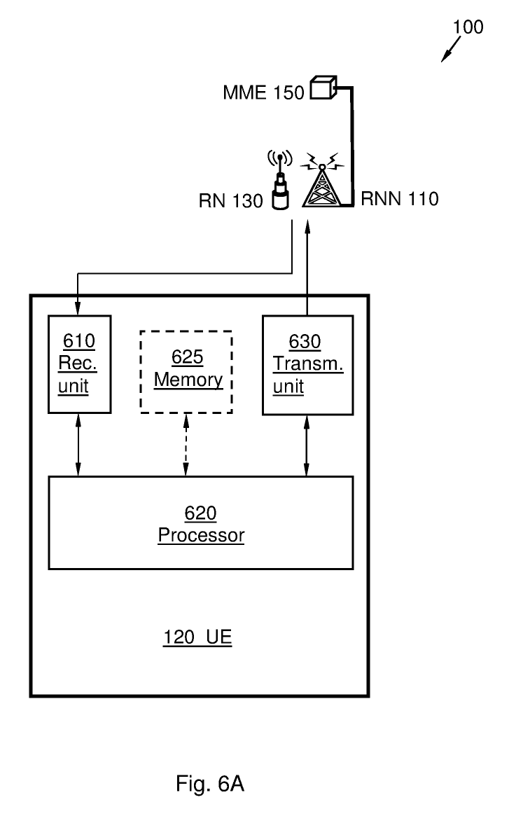

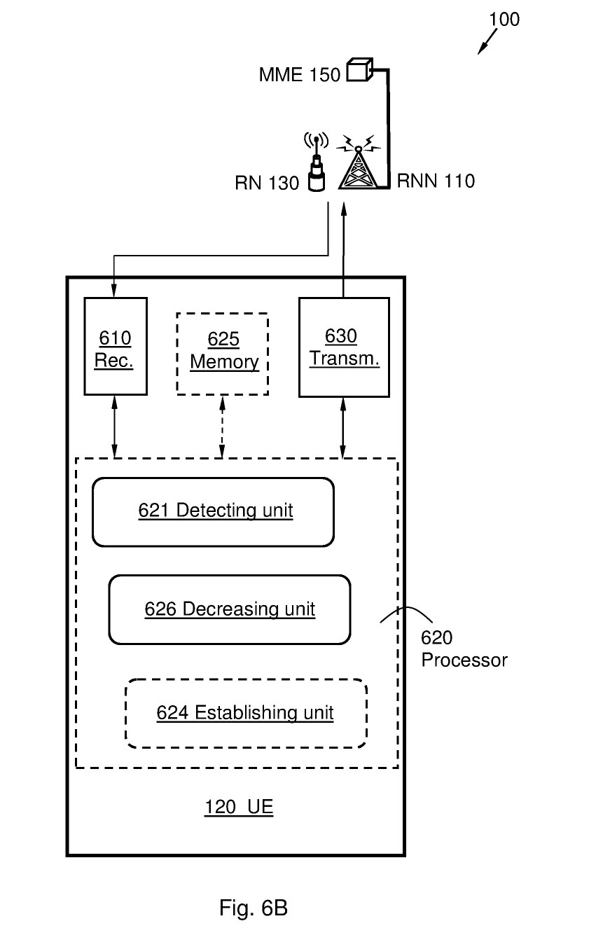

FIG. 6A illustrates an embodiment of a user equipment 120, configured for wireless communication in a wireless communication system 100. The user equipment 120 is further configured for performing the method 500 according to at least some of the previously described actions 501-505 for saving transmission energy by decreasing transmission power of the user equipment 120, which user equipment 120 is served by a serving radio network node 110 in a heterogeneous wireless communication system 100 comprising the radio network node 110, a relay node 130 and a management node 150.

The wireless communication network 100 may be based on 3GPP LTE. Further, the wireless communication system 100 may be based on FDD or TDD in different embodiments. The radio network node 110 may comprise an evolved NodeB (eNodeB) according to some embodiments. The management node 150 may comprise a Mobility Management Entity (MME). The relay node 130 may comprise a micro node, a pico node, a nano node, or similar entity.

According to some embodiments, information confirming that the user equipment 120 is in saving energy mode may be communicated over an intra-radio network node connection, such as S1 and/or X2, enabling the user equipment 120 to continue transmitting in saving energy mode also after a hand-over.

The user equipment 120 comprises a processor 620, configured for decreasing the transmission power of the user equipment 120, when transmitting in the uplink.

Further, the processor 620 may be configured for detecting a battery energy level of the user equipment 120, which is lower than a threshold level in some embodiments.

The processor 620 may further be configured for estimating whether the remaining battery level will be sufficient to support the active services for a predicted time until the battery can be recharged and detect that the battery energy level of the user equipment 120 is low when the remaining battery level is insufficient.

The processor 620 may further be configured for decreasing the transmission power of the user equipment 120 by decreasing the Quality of Service (QoS) of the user equipment 120, for transmissions in the uplink.

The processor 620 may in further addition be configured for decreasing the transmission power of the user equipment 120 when a user permission is retrieved. Such user permission may be retrieved by the management node 150 from a data base such as e.g. the management node 150 according to some embodiments.

The processor 620 may furthermore be configured for establishing an uplink connection with the relay node 130, for enabling forwarding of a signal from the user equipment 120 to the radio network node 110 via the relay node 130, and thereby decrease the transmission power of the user equipment 120.

Also, according to some embodiments, the processor 620 may be further configured for obtaining location information related to the user equipment 120, and also configured for adding said location information to the request for saving transmission energy, thereby enabling geographical localisation of the user equipment 120 for the recipient of the request.

The processor 620 may also be further configured for obtaining information characterising how the energy consumption of the user equipment 120 depend on the transmission power of the user equipment 120, and also configured for adding said information to the request for saving transmission energy in some embodiments.

Furthermore, the processor 620 may further be configured, in some embodiments, for computing a transmission power threshold of the user equipment 120 and add said transmission power threshold to the request for saving transmission energy to be transmitted.

Such processor 620 may comprise one or more instances of a processing circuit, i.e. a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

Further, the user equipment 120 comprises a transmitter 630, configured for transmitting a request for saving transmission energy. Such transmitter 630 may be configured for transmitting wireless radio signals, to be received by e.g. the management nodes 150, for example via the radio network node 110, or the relay node 130.

In further addition, the user equipment 120 comprises a receiver 610, configured for receiving a response, comprising an instruction for decreasing the transmission power of the user equipment 120. The receiver 610 may thus be configured for receiving radio signals over a wireless interface. The radio signals may be received from, e.g., the radio network node 110, the relay node 130, or any other entity configured for wireless communication according to some embodiments.

Furthermore, the user equipment 120 may further comprise at least one memory 625, according to some embodiments. The optional memory 625 may comprise a physical device utilised to store data or programs, i.e., sequences of instructions, on a temporary or permanent basis. According to some embodiments, the memory 625 may comprise integrated circuits comprising silicon-based transistors. Further, the memory 625 may be volatile or non-volatile.

The above described actions 501-505 to be performed in the user equipment 120 may be implemented through the one or more processors 620 in the user equipment 120, together with computer program product for performing at least some of the functions of the actions 501-505. Thus a computer program product, comprising instructions for performing the actions 501-505 in the user equipment 120 may save transmission energy by decreasing transmission power of the user equipment 120 when the computer program is loaded into the processor 620 of the user equipment 120.

Thereby a computer program product may comprise a computer readable storage medium storing program code thereon for use by a user equipment 120 for saving transmission energy by decreasing transmission power of the user equipment 120. The program code comprising instructions for executing a method 500 comprising: transmitting 502 a request for saving transmission energy. In addition, the method 500 furthermore comprises receiving 503 a response, comprising an instruction for decreasing the transmission power of the user equipment 120. Additionally, the method 500 comprises decreasing 505 the transmission power of the user equipment 120, when transmitting in the uplink.

The computer program product mentioned above may be provided for instance in the form of a data carrier carrying computer program code for performing at least some of the actions 501-505 according to some embodiments when being loaded into the processor 620. The data carrier may be, e.g., a hard disk, a CD ROM disc, a memory stick, an optical storage device, a magnetic storage device or any other appropriate medium such as a disk or tape that may hold machine readable data in a non transitory manner. The computer program product may furthermore be provided as computer program code on a server and downloaded to the user equipment 120 remotely, e.g., over an Internet or an intranet connection.

FIG. 6B illustrates an embodiment of a user equipment 120, configured for wireless communication in a wireless communication system 100, similar to the embodiment illustrated in FIG. 6A.

In the illustrated alternative embodiment, the processor 620, and/or the user equipment 120 may comprise a detecting unit 621, a decreasing unit 626 and possibly an establishing unit 624 according to some embodiments.

According to some such embodiments, the detecting unit 621 may be configured for detecting a battery energy level of the user equipment 120, which is lower than a threshold level. The detecting unit 621 may also be part of a context aware energy management that adapts the battery level threshold depending on the active application and services in the user equipment 120, as well as predicted battery life time in some embodiments.

Furthermore, in some such embodiments, the decreasing unit 626 may be configured for decreasing the transmission power of the user equipment 120, when transmitting in the uplink.

The decreasing unit 626 may in some embodiments be configured for decreasing the transmission power of the user equipment 120 based on a decrease of the Quality of Service (QoS) of the user equipment 120, for transmissions in the uplink.

According to some embodiments, the decreasing unit 626 may decrease the transmission power of the user equipment 120 when a user permission is retrieved.

Optionally, according to some embodiments, the establishing unit 624 may be configured for establishing an uplink connection with the relay node 130, for enabling forwarding of a signal from the user equipment 120 to the radio network node 110 via the relay node 130, and wherein the decrease of the transmission power of the user equipment 120 may be enabled due to the established uplink connection with the relay node 130.

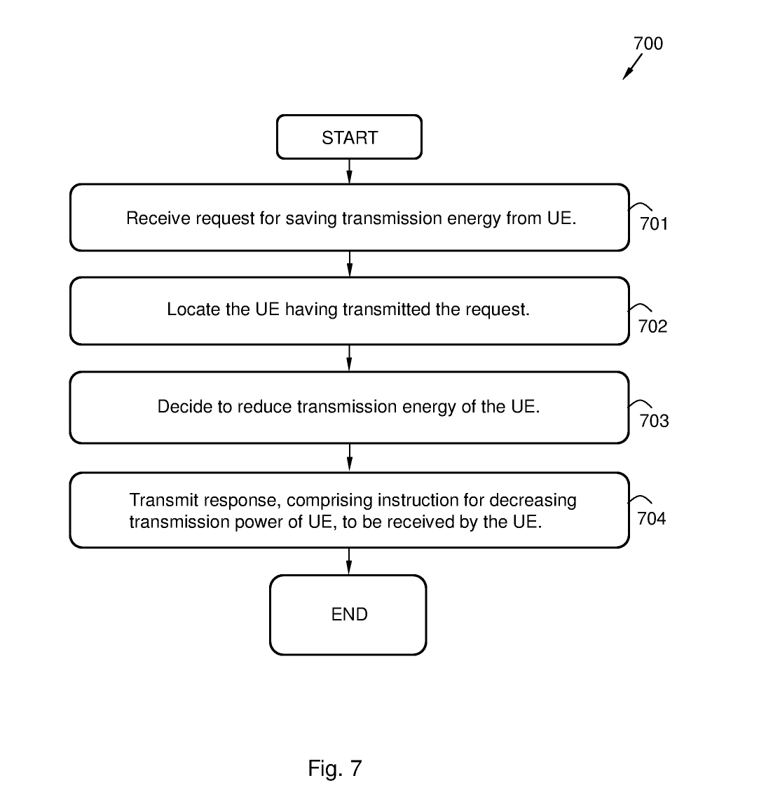

FIG. 7 is a flow chart illustrating embodiments of a method 700 for use in a management node 150 in a heterogeneous wireless communication system 100 comprising a radio network node 110, a relay node 130, besides the management node 150. A user equipment 120 is attached to the wireless communication system 100 served by the radio network node 110. The method 700 comprises saving transmission energy of the user equipment 120 by decreasing transmission power of the user equipment 120.

The wireless communication network 100 may be based on 3GPP LTE. Further, the wireless communication system 100 may be based on FDD or TDD in different embodiments. The radio network node 110 may comprise an evolved NodeB (eNodeB) according to some embodiments. The management node 150 may comprise a Mobility Management Entity (MME). The relay node 130 may comprise a micro node, a pico node, a nano node, or similar entity.

According to some embodiments, information confirming that the user equipment 120 is in saving energy mode may be communicated over an intra-radio network node connection, such as S1 and/or X2, enabling the user equipment 120 to continue transmitting in saving energy mode also after a hand-over.

To appropriately save transmission energy by decreasing transmission power of the user equipment 120, the method 700 may comprise a number of actions 701-704.

It is however to be noted that any, some or all of the described actions 701-704, may be performed in a somewhat different chronological order than the enumeration indicates, be performed simultaneously or even be performed in a completely reversed order according to different embodiments. Further, it is to be noted that some actions may be performed in a plurality of alternative manners according to different embodiments, and that some such alternative manners may be performed only within some, but not necessarily all embodiments. The method 700 may comprise the following actions:

### Action 701

A request for saving transmission energy from the user equipment 120 is received.

The reception of such request may trigger the performance of the subsequently following actions in some embodiments.

### Action 702

The user equipment 120 having transmitted the request is located geographically.

The location of the user equipment 120 may be based on location information received 701 from the user equipment 120 according to some embodiments.

Such location information may comprise a geographical location determined by GPS, by triangulation of radio signals, registered by the user of the user equipment 120, by determining the serving network node, a radio signal fingerprint comprising signal strength of received reference signals, or similar manner.

The location of the user equipment 120 may be based on information retrieved from a location service.

Thereby, by determining the geographical location of the user equipment 120, it is possible to determine if the user equipment 120 is situated e.g. close to a relay node 130 within the wireless communication system 100, as the management node 150 may have knowledge of the geographical locations of relay nodes 130 and radio network nodes 110 within the wireless communication system 100 in some embodiments, or may access such information from a data base. Based on such knowledge, it may be determined to let the user equipment 120 attach the network via a relay node 130 in the uplink, for saving transmission power according to some embodiments.

### Action 703

It is decided to reduce the transmission energy of the user equipment 120.

The decision to reduce the transmission energy of the user equipment 120 is based on a decrease of the Quality of Service (QoS) of the user equipment 120 in the uplink, when the channel quality between the user equipment 120 and the serving radio network node 110 exceeds a threshold quality level. The threshold level for the quality may be set according to the requirements of the applications and services that are being used by the user equipment 120.

The decision to reduce the transmission energy of the user equipment 120 may be based on a rerouting of uplink signals from the user equipment 120 to the radio network node 110 via the relay node 130 when channel quality between the user equipment 120 and relay node 130 may be better than the channel quality between the user equipment 120 and the radio network node 110, according to some embodiments.

### Action 704

A response, comprising an instruction for decreasing the transmission power of the user equipment 120 is transmitted. The response is transmitted in order to be received by the user equipment 120.

Thereby, it is possible to reduce the transmission power of the user equipment 120 and thereby saving energy of the user equipment 120.

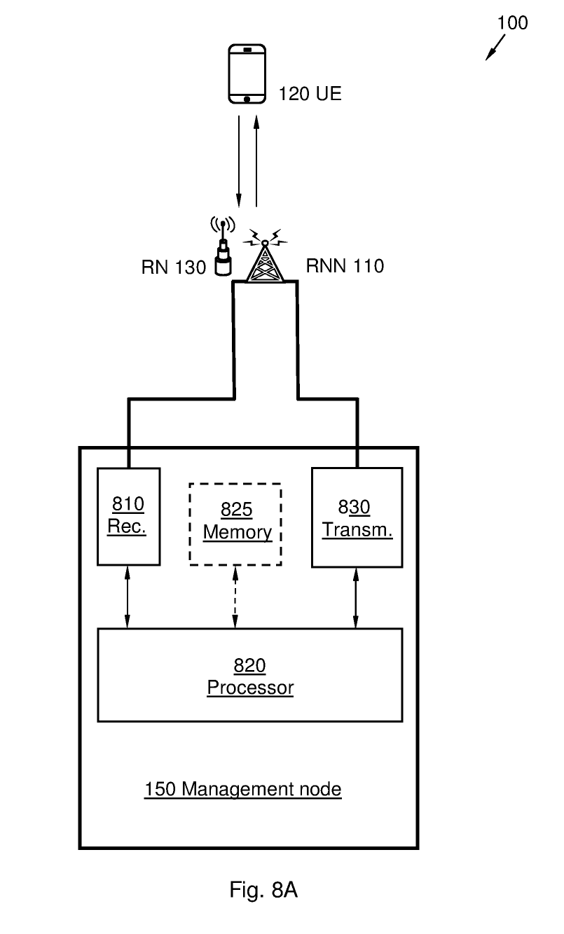

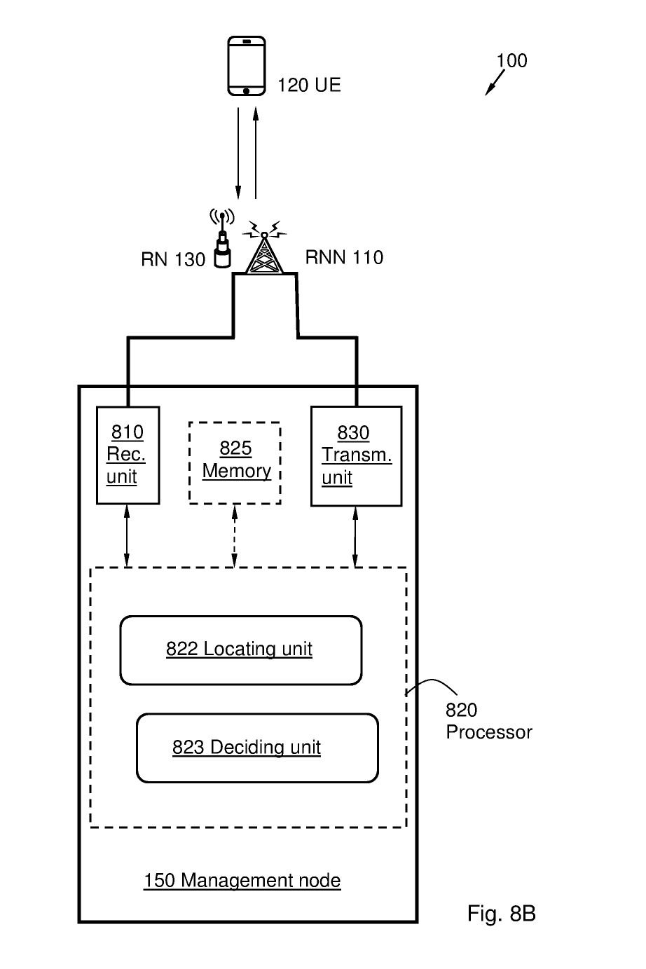

FIG. 8A illustrates an embodiment of a management node 150, configured for communication in a heterogeneous wireless communication system 100. The heterogeneous wireless communication system 100 comprises a radio network node 110, a relay node 130, besides the management node 150. A user equipment 120 served by the radio network node 110 is attached to the wireless communication system 100. The management node 150 may be connectable to the radio network node 110 and/or the relay node 130 over a wired, or a wireless connection according to different embodiments.

The management node 150 is configured for performing the method 700 according to at least some of the previously described actions 701-704 for saving transmission energy by decreasing transmission power of the user equipment 120.

The wireless communication network 100 may be based on 3GPP LTE. Further, the wireless communication system 100 may be based on FDD or TDD in different embodiments. The radio network node 110 may comprise an evolved NodeB (eNodeB) according to some embodiments. The management node 150 may comprise a Mobility Management Entity (MME). The relay node 130 may comprise a micro node, a pico node, a nano node, or similar entity.

According to some embodiments, information confirming that the user equipment 120 is in saving energy mode may be communicated over an intra-radio network node connection, such as S1 and/or X2, enabling the user equipment 120 to continue transmitting in saving energy mode also after a hand-over.

The management node 150 comprises a receiver 810, configured for receiving a request for saving transmission energy, from the user equipment 120. The receiver 810 may be configured for receiving wired signals, or alternatively radio signals over a wireless interface. The signals may be received from, e.g., the radio network node 110, the relay node 130, or any other entity configured for communication within the wireless communication system 100, according to some embodiments.

In addition, the management node 150 also comprises a processor 820, configured for locating the user equipment 120 having transmitted the request, and also configured for deciding to reduce the transmission energy of the user equipment 120.

The processor 820 may be further configured for determining that the user equipment 120 is located closer to the serving radio network node 110 than a threshold distance, and also configured for decreasing the Quality of Service (QoS) of the user equipment 120 in the uplink, according to some embodiments.

Further, the processor 820 according to some embodiments may also be configured for determining that the channel quality between the user equipment 120 and relay node 130 is better than the channel quality between the user equipment 120 and the radio network node 110, and also configured for rerouting uplink signals of the user equipment 120, to the radio network node 110 via the relay node 130.

In some alternative embodiments, the processor 820 may be further configured for retrieving location information from a location service and for locating the user equipment 120 based on such retrieved information. Said location information for locating the user equipment 120 may comprise geographical information determined e.g. by GPS, by triangulation of received signals by the user equipment 120, a signal fingerprint comprising signal strength/quality measurements such as RSRP or RSRQ made by the user equipment 120 and reported to the management node 150 upon request. Such signal fingerprints may be stored in a data based, mapped with an estimated geographical location according to some embodiments.

Such processor 820 may comprise one or more instances of a processing circuit, i.e. a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

Furthermore, the management node 150 also comprises a transmitter 830, configured for transmitting a response, comprising an instruction for decreasing the transmission power of the user equipment 120 to be received by the user equipment 120. Such response may be transmitted over a wired interface, or over a wireless interface according to different embodiments.

Furthermore, the management node 150 may further comprise at least one memory 825, according to some embodiments. The optional memory 825 may comprise a physical device utilised to store data or programs, i.e., sequences of instructions, on a temporary or permanent basis. According to some embodiments, the memory 825 may comprise integrated circuits comprising silicon-based transistors. Further, the memory 825 may be volatile or non-volatile.

The above described actions 701-704 to be performed in the management node 150 may be implemented through the one or more processors 820 in the management node 150, together with computer program product for performing at least some of the functions of the actions 701-704. Thus a computer program product, comprising instructions for performing the actions 701-704 in the management node 150 may save transmission energy by decreasing transmission power of the user equipment 120 when the computer program is loaded into the processor 820 of the management node 150.

Thereby a computer program may comprise program code for performing the method 700 according to any of actions 701-704 for use in the management node 150, for saving transmission energy by decreasing transmission power of a user equipment 120, when the computer program is loaded into the processor 820 of the management node 150.

Further, in some embodiments, a computer program product may comprise a computer readable storage medium storing program code thereon for use by a management node 150, for saving transmission energy by decreasing transmission power of a user equipment 120. The program code comprises instructions for executing a method 700 comprising receiving 701 a request for saving transmission energy from the user equipment 120. Further, the method 700 also comprises locating 702 the user equipment 120 having transmitted said request. In addition, the method 700 furthermore comprises deciding 703 to reduce the transmission energy of the user equipment 120. The method 700 also comprises transmitting 704 a response, comprising an instruction for decreasing the transmission power of the user equipment 120, to be received by the user equipment 120.

The computer program product mentioned above may be provided for instance in the form of a data carrier carrying computer program code for performing at least some of the actions 701-704 according to some embodiments when being loaded into the processor 820 of the management node 150. The data carrier may be, e.g., a hard disk, a CD ROM disc, a memory stick, an optical storage device, a magnetic storage device or any other appropriate medium such as a disk or tape that may hold machine readable data in a non transitory manner. The computer program product may furthermore be provided as computer program code on a server and downloaded to the management node 150 remotely, e.g., over an Internet or an intranet connection.

FIG. 8B illustrates an embodiment of a management node 150 in a wireless communication system 100, similar to, or even identical with the embodiment illustrated in FIG. 8A.

In the illustrated alternative embodiment, the processor 820, and/or the management node 150 may comprise a locating unit 822 and a deciding unit 823, according to some embodiments.

According to some such embodiments, the locating unit 822 may be configured for locating the user equipment 120 having transmitted a request for saving transmission energy, which has been received by the management node 150. Such location of the user equipment 120 may be made e.g. by extracting an indicated geographical location comprised in the request; by extracting signal measurements such as RSRP and/or RSRQ, which may be mapped against possible geographical locations in a data base according to some embodiments.

The deciding unit 823 may be configured to decide to reduce the transmission energy of the user equipment 120. Such decision may be based on the geographical location of the user equipment 120. When the user equipment 120 is situated close to a relay node 130, or close to the cell border of the relay node 130, the user equipment 120 may reduce transmission energy by transmitting via the relay node 130 in the uplink. The downlink communication may remain via the radio network node 110 according to some embodiments. Thereby, the user equipment 120 may enjoy good throughput and signalling quality in the downlink while reducing the transmission power in the uplink.

According to some embodiments, the deciding unit 823 may decide to reduce the transmission energy of the user equipment 120 by reducing the QoS level of the user equipment 120 according to some embodiments, for transmissions in the uplink. However, in some embodiments, the transmission power of the user equipment 120 may be decreased when a user permission is retrieved.

The terminology used in the description of the embodiments as illustrated in the accompanying drawings is not intended to be limiting of the described methods 500, 700; user equipment 120 and/or management node 150. Various changes, substitutions and/or alterations may be made, without departing from the invention as defined by the appended claims.

As used herein, the term “and/or” comprises any and all combinations of one or more of the associated listed items. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

1. A method for use in a User Equipment, UE, for saving transmission energy by decreasing transmission power of the user equipment, which user equipment is served by a serving radio network node in a heterogeneous wireless communication system comprising the radio network node, a relay node and a management node, the method comprising:
transmitting a request for saving transmission energy;
receiving a response, comprising an instruction for decreasing the transmission power of the user equipment; and
decreasing the transmission power of the user equipment, when transmitting in the uplink.

2. The method according to claim 1, further comprising:
detecting a battery energy level of the user equipment, which is lower than a battery energy threshold level.

3. The method according to claim 2, wherein the battery energy threshold level is not a fixed level, but based on an estimation of whether the remaining battery energy level will be sufficient to support the active services for a predicted time until the battery can be recharged.

4. The method according to claim 1, wherein the decrease of the transmission power of the user equipment is made based on a decrease of the Quality of Service, QoS, of the user equipment, for transmissions in the uplink.

5. The method according to claim 1, further comprising
establishing an uplink connection with the relay node, for enabling forwarding of a signal from the user equipment to the radio network node via the relay node, and wherein the decrease of the transmission power of the user equipment is enabled due to the established uplink connection with the relay node.

6. The method according to claim 1, wherein the request for saving transmission energy comprises location information related to the user equipment, for enabling a geographical localisation of the user equipment.

7. The method according to claim 1, wherein the transmitted request for saving transmission energy comprises information characterising how the energy consumption of the user equipment depends on the transmission power of the user equipment.

8. The method according to claim 1, wherein the request for saving transmission energy is transmitted to the management node, which in response prepare an instruction for decreasing the transmission power of the user equipment.

9. The method according to claim 1, wherein the request for saving transmission energy comprises a transmission power threshold of the user equipment.

10. A user equipment, configured for saving transmission energy by decreasing transmission power of the user equipment, which user equipment is served by a serving radio network node in a heterogeneous wireless communication system comprising the radio network node, a relay node and a management node, the user equipment comprising:
a processor, configured for decreasing the transmission power of the user equipment, when transmitting in the uplink;
a transmitter, configured for transmitting a request for saving transmission energy; and
a receiver, configured for receiving a response, comprising an instruction for decreasing the transmission power of the user equipment.

11. The user equipment according to claim 10, wherein the processor is further configured for detecting a battery energy level of the user equipment, which is lower than a threshold level.

12. The user equipment according to claim 11, wherein the processor is further configured for estimating whether the remaining battery level will be sufficient to support the active services for a predicted time until the battery can be recharged and detect the low battery energy level of the user equipment when the remaining battery level is not sufficient.

13. The user equipment according to claim 10, wherein the processor is further configured for decreasing the transmission power of the user equipment by decreasing the Quality of Service, QoS, of the user equipment, for transmissions in the uplink.

14. The user equipment according to claim 10, wherein the processor is further configured for establishing an uplink connection with the relay node, for enabling forwarding of a signal from the user equipment to the radio network node via the relay node, and thereby decrease the transmission power of the user equipment.

15. The user equipment according to claim 10, wherein the processor is further configured for obtaining location information related to the user equipment, and also configured for adding said location information to the request for saving transmission energy, thereby enabling geographical localisation of the user equipment for the recipient of the request.

16. The user equipment according to claim 10, wherein the processor is further configured for obtaining information characterising how the energy consumption of the user equipment depends on the transmission power of the user equipment, and also configured for adding said information to the request for saving transmission energy.

17. The user equipment according to claim 10, wherein the processor is further configured for computing a transmission power threshold of the user equipment and add said transmission power threshold to the request for saving transmission energy to be transmitted.

18. A method for use in a management node in a heterogeneous wireless communication system comprising a radio network node, a relay node and the management node, wherein a user equipment is attached to the wireless communication system served by the radio network node, and wherein said method comprises saving transmission energy of the user equipment by decreasing transmission power of the user equipment, the method comprising:
receiving a request for saving transmission energy from the user equipment;
locating the user equipment having transmitted said request;
deciding to reduce the transmission energy of the user equipment; and
transmitting a response, comprising an instruction for decreasing the transmission power of the user equipment, to be received by the user equipment.

19. The method according to claim 18, wherein the decision to reduce the transmission energy of the user equipment is based on a decrease of the Quality of Service of the user equipment in the uplink, when the channel quality between the user equipment and the serving radio network node is better than a threshold quality value.

20. The method according to claim 18, wherein the decision to reduce the transmission energy of the user equipment is based on a rerouting of uplink signals from the user equipment to the radio network node via the relay node when channel quality between the user equipment and relay node is better than the channel quality between the user equipment and the radio network node.

21. The method according to claim 18, wherein the location of the user equipment is based on location information received from the user equipment or a location service.

22. A management node in a heterogeneous wireless communication system comprising a radio network node, a relay node and the management node, wherein a user equipment is attached to the wireless communication system served by the radio network node, the management node comprising:
a receiver, configured for receiving a request for saving transmission energy, from the user equipment;
a processor, configured for locating the user equipment having transmitted said request, and also configured for deciding to reduce the transmission energy of the user equipment; and
a transmitter, configured for transmitting a response, comprising an instruction for decreasing the transmission power of the user equipment, to be received by the user equipment.

23. The management node according to claim 22, wherein the processor is further configured for determining that the channel quality between the user equipment and the serving radio network node is better than a threshold quality level, and also configured for decreasing the Quality of Service of the user equipment in the uplink.

24. The management node according to claim 22, wherein the processor is further configured for determining that the channel quality between the user equipment and relay node is better than the channel quality between the user equipment and the radio network node, and also configured for rerouting uplink signals of the user equipment, to the radio network node via the relay node.

25. The management node according to claim 22, wherein the processor is further configured for retrieving location information from a location service and for locating the user equipment based on such retrieved information.
